(19) United States
(12) Patent Application Publication
(10) Pub. No.: US 2019/0050897 A1
(43) Pub. Date: Feb. 14, 2019

(54) A METHOD FOR DELIVERING A TARGETED ADVERTISING TO A SELECTED SET OF RECIPIENT USERS, AS WELL AS A CORRESPONDING COMPUTING SERVER

(71) Applicant: 4C INSIGHTS, INC., Chicago, IL (US)

(72) Inventor: Sean BREEDLOVE, Chicago, IL (US)

(21) Appl. No.: 16/085,788

(22) PCT Filed: May 10, 2016
(86) PCT No.: PCT/IB2016/052668

§ 371 Date: Sep. 17, 2018

Related U.S. Application Data
(60) Provisional application No. 62/308,317, filed on Mar. 15, 2016.

(51) Int. Cl. G06Q 30/02; G06Q 50/00

(52) U.S. Cl. CPC G06Q 30/0255; G06Q 50/01; G06Q 30/0267

(57) ABSTRACT

A method for delivering a targeted advertising to a selected set of recipient users, comprising the steps of retrieving anonymized social media user engagement behaviour at a first social media platform to define an audience segment desired to inform the targeting of advertising on said second platform, determining engagement patterns of the plurality of anonymous user identifications across a matrix, determining strengths of relationships between said plurality of recipient users and said one or more particular behavioural variables, selecting a set of recipient users being a subset of said plurality of recipient users at said second platform to which said advertising is to be delivered, and delivering at said second platform, said advertising to said selected set of recipient users.

The present invention is related to a method for delivering a targeted advertising to a selected set of recipient users, more specifically, to method steps for selecting a desired set of recipient users to which said targeted advertising is to be sent.

Advertising is some sort of marketing tool which is used to establish a brand, profile a brand, promote a brand, etc., for example related to a particular product or service. Advertisement messages and/or commercials may be spread via a variety of media such a television advertisement, radio advertisement, newspapers, etc.

Two different types of advertising exist, commercial advertising and non-commercial advertising. Commercial advertising is intended to increase consumption of product or services through branding, which associates a product name or image with certain qualities in the minds of the customers. Non-commercial advertisers who spend money to advertise items other that a consumer product or service include political parties, interest groups, religious organizations and government agencies. Non-profit organizations may use free modes of persuasion, such as a public service announcement.

A television advertisement, for example, is a span of television programming produced and paid for by an organization, which conveys a message, typically to market a product or service. The vast majority of television advertisements today consist of brief advertising spots, ranging in length from a few seconds to several minutes. Advertisements of this sort have been used to promote a wide variety of goods, services and ideas since the beginning of television.

Nowadays, the viewership of television programming is often used as a metric for television advertisement placement, and consequently, for the rates charged to advertisers to air within a given network, television program, or time of day. It is well known that advertisers select television programs which relate to their products and/or services the most. That is, studies have demonstrated that there's a correlation between a television program and particular brands. This information is then used to select most appropriate advertising message, i.e. the advertising message which best fits the viewer of that particular television program.

One of the drawbacks of the above described method for selecting when, and which, advertisement message is to be delivered is not ideal, as the advertisement messages are not coupled to users but to television programs. More generally, it is a drawback that known methods do not couple advertisement messages to the actual behaviour of users.

It is therefor an object of the invention to provide for a method as well as a computing server in which a set of recipient users is selected and an advertisement is delivered to that set of recipient users, wherein the selection process of the users is improved such that advertisements are tuned to the user in a more tailored manner.

In order to achieve that object, the invention provides, in a first aspect in a method for delivering a targeted advertising to a selected set of recipient users, said method being performed by a computing server in connection with a recipient database comprising a plurality of recipient users at a second platform as well as one or more behavioural variables, said method comprising the steps of:

a) retrieving, by said computing server, anonymized social media user engagement behaviour at a first social media platform to define an audience segment desired to inform the targeting of advertising on said second platform, said audience segment comprising a plurality of anonymous user identifications, and wherein said engagement behaviour is defined as an affinity of each of said plurality of anonymous user identifications with one or more brands;
b) determining, by said computing server, using said retrieved anonymized social media user engagement behaviour, engagement patterns of the plurality of anonymous user identifications across a matrix, said matrix having a first dimension related to said one or more brands and a second dimension related to said one or more particular behavioural variables, thereby obtaining relationships of said one or more brands with said one or more particular behavioural variables;
c) determining, by said computing server, by accessing said recipient database, strengths of relationships between said plurality of recipient users and said one or more particular behavioural variables, thereby obtaining relationships of said plurality of recipient users with said one or more particular behavioural variables;
d) selecting, by said computing server, a set of recipient users being a subset of said plurality of recipient users at said second platform to which said advertising is to be delivered, said selecting based on said obtained relationships of:
said one or more brands with said one or more particular behavioural variables, and
said plurality of recipient users with said one or more particular behavioural variables;
   e) delivering, by said computing server, at said second platform, said advertising to said selected set of recipient users.

It was the insight of the inventors that social media platforms comprise rich behavioural data that can be mined to define segments of value for the application in the fields of media and marketing. However, these social media platforms do not allow for a deterministic database match to other data sets, but do facilitate analytics to be run using anonymous user identifications or provide methods to query methods that return aggregated metrics that are calculated using user level data.

As such, the inventors found that the data retrieved from a first social media network can be used to establish engagement patterns of the plurality of anonymous user identifications across a matrix, wherein the matrix has a first dimension related to the one or more brands and a second dimension related to one or more particular behavioural variables, for example television programs or purchase behaviour. As such, relationships between television programs and brands is established. Again, these relationships are established using data coming from a first social media platform like, for example, Twitter®. These relationships may reflect the strengths, i.e. the strengths of the relationships, of each of the brands with each of the television programs.

Parallel, or subsequent, to the above, relationships are established between recipient users present in the recipient database and the same one or more behavioural variables. In the present case, for example, television programs. These relationships may comprise a likelihood that a particular recipient user is watching a particular television program, or an affinity of a particular recipient user with a particular television program, etc.

Based on the above two aspects, a set of recipient users are selected from the recipient database, which set of recipient users is a subset of the plurality of recipient users in the database. The recipient users are thus the users present on the second platform, i.e. the television platform, to which said advertisement is to be delivered.

In accordance with the present invention, the method may be performed in real-time, quasi real-time, or with a predetermined time delay. That is, the steps a), b), c) and d) may be performed just before step e) is performed, but may also be performed once a day, once a week, once a month, etc. It may be advantageous not to perform the steps a), b) and c) too often as these steps may be resource intensive.

In an example, the step b) further comprises the step of:
calculating, by said computing server, indices that quantify strengths of said relationships of said one or more brands with said one or more particular behavioural variables.

The advantage hereof is that not only a relationships between brands and the behavioural variables are established, but also a measure about how strong those relationships are. For example, is a brand firmly coupled to a behavioural variable or is the brand loosely coupled to that behavioural variable. All of these aspect may impact whether a user is eventually selected or not.

In another example, the step c) further comprises the step of:
calculating, by said computing server, indices that quantify strengths of said relationships of said plurality of recipient users with said one or more particular behavioural variables.

Here, step d) may further comprise:
selecting a set of recipient users based on a calculated degree of similarity of indices related to said strengths of said relationships of said one or more brands with said one or more particular behavioural variables, for example purchase variables, and said indices related to said strengths of said relationships of said plurality of recipient users with said one or more particular behavioural variables.

As mentioned above, said one or more behavioural variables may comprise television programs, television shows, movies, etc.

In another example, step c) comprises determining, by said computing server, by accessing said recipient database, strengths of relationships between said plurality of recipient users and said one or more particular behavioural variables by analysing historic user patterns of said plurality of recipient users with respect to said one or more particular behavioural variables.

In a second aspect of the invention there is provided a computing server for delivering a targeted advertising to a selected set of recipient users, said computing server in connection with a recipient database comprising a plurality of recipient users at a second platform as well as one or more behavioural variables, said computing server comprising:

retrieve equipment arranged for retrieving anonymized social media user engagement behaviour at a first social media platform to define an audience segment desired to inform the targeting of advertising on said second platform, said audience segment comprising a plurality of anonymous user identifications, and wherein said engagement behaviour is defined as an affinity of each of said plurality of anonymous user identifications with one or more brands;

determine equipment arranged for determining using said retrieved anonymized social media user engagement behaviour, engagement patterns of the plurality of anonymous user identifications across a matrix, said matrix having a first dimension related to said one or more brands and a second dimension related to said one or more particular behavioural variables, thereby obtaining relationships of said one or more brands with said one or more particular behavioural variables;

process equipment arranged for determining, by accessing said recipient database, strengths of relationships between said plurality of recipient users and said one or more particular behavioural variables, thereby obtaining relationships of said plurality of recipient users with said one or more particular behavioural variables;

select equipment arranged for selecting a set of recipient users being a subset of said plurality of recipient users at said second platform to which said advertising is to be delivered, said selecting based on said obtained relationships of:
said one or more brands with said one or more particular behavioural variables, and
said plurality of recipient users with said one or more particular behavioural variables;

deliver equipment arranged for delivering at said second platform, said advertising to said selected set of recipient users.

The expressions, i.e. the wording, of the different aspects comprised by the method and computing server according to the present disclosure should not be taken literally. The wording of the aspects is merely chosen to accurately express the rationale behind the actual functioning of the aspects.

In accordance with the present disclosure, different aspects applicable to the above mentioned examples of the methods, including the advantages thereof, correspond to the aspects which are applicable to the computing server according to the present disclosure.

In an example, the determine equipment is further arranged for:
calculating, by said computing server, indices that quantify strengths of said relationships of said one or more brands with said one or more particular behavioural variables.

In a further example, the process equipment is further arranged for:
calculating, by said computing server, indices that quantify strengths of said relationships of said plurality of recipient users with said one or more particular behavioural variables.

In another example, the select equipment is further arranged for:
selecting a set of recipient users based on a calculated degree of similarity of indices related to said strengths of said relationships of said one or more brands with said one or more particular behavioural variables and said indices related to said strengths of said relationships of said plurality of recipient users with said one or more particular behavioural variables.

According to the present invention, the one or more behavioural variables may comprise television programs.

In an even further example, said process equipment is further arranged for determining, by said computing server, by accessing said recipient database, strengths of relationships between said plurality of recipient users and said one or more particular behavioural variables by analysing historic user patterns of said plurality of recipient users with respect to said one or more particular behavioural variables.

The above-mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

FIG. 1 illustrates the process flow of translating segmentations defined by social media engagement patterns to a television audience measurement panel dataset.

FIG. 2 contains an example of records of anonymous social media user IDs that have qualified for brand segments by engaging with a brand on a social media network.

FIG. 3 is an example of a matrix of TV program engagement indices for a set of 4 brand segments defined using social media behaviour.

FIG. 4 contains example records of user level television engagement indices based on historic viewing patterns.

FIG. 5 contains a table of random sample records containing a measure of statistical similarity of viewing patterns across the matrix TV programs in the TV audience measurement panel to the the matrix of common TV program social media engagements of the audience segment sourced from the behaviour of users of social media networks.

FIG. 6 illustrates ranking TV audience measurement panelists by descending order by similarity score and selecting the top 40% of users as being in the discrete target audience.

FIG. 7 illustrates a flow chart illustrating the method according to the present invention.

FIG. 8 illustrates a computing server in according with the present invention.

### DETAILED DESCRIPTION

The present invention is directed to address the challenges presented by social networks and other closed environments which have rich behavioural data that can be mined to define segments of value for the application in the fields of media and marketing, but the first social media platform holder does not permit a database match to other data sets, but facilitates analytics to be run using anonymous user identifications.

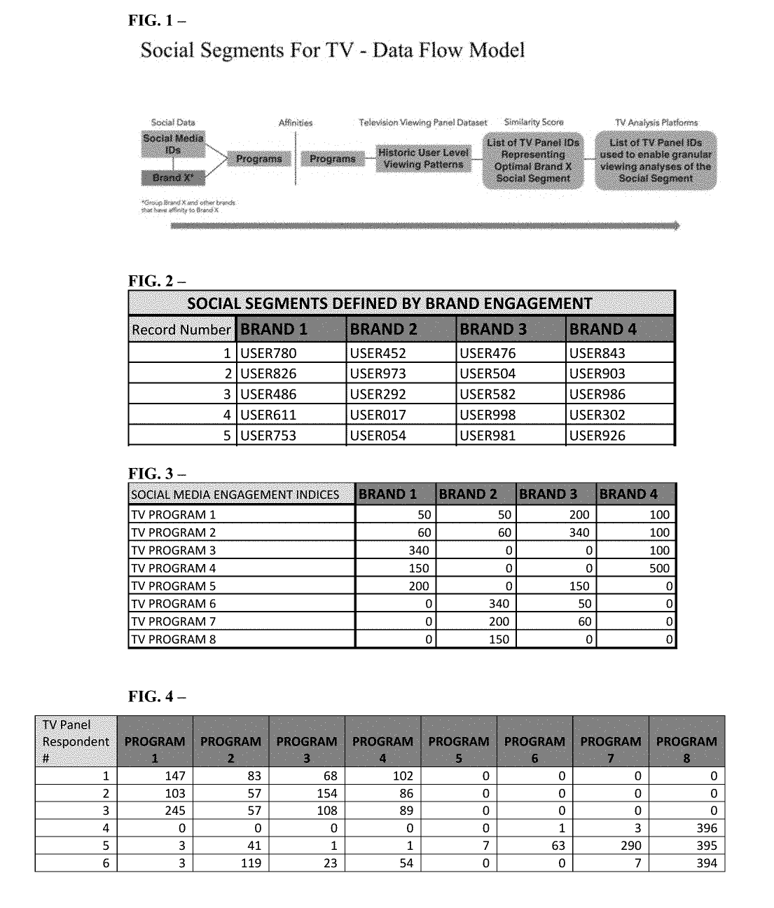

FIG. 1 illustrates a sample process flow of taking social media segments defined using user brand engagement and using television programs as the mechanism to inform the segment classification of respondents in a television audience measurement panel using viewing patterns. Here, it is shown that data relating to the social media ID's, i.e. the anonymous user identifications, the different brands and the television programs are retrieved from the first social media network, for example a first social media network server. The retrieved television programs are aligned with the television programs are aligned to the television programs known in the second platform in order to establish a correct match between these two variables.

Historic user level viewing patterns may then be determined by the computing server by accessing and analysing the recipient database.

Using the two determination steps according to the present claim 1, a correct subset of recipient users may be selected for delivering the advertising thereto.

Behaviour on social media networks used to define an audience segment that resolves to a list of anonymous social media IDs as illustrated in FIG. 2. That is, FIG. 2 shows a list of different brands and which anonymized users are coupled to which brand. These relationships are established based on the data retrieved from the first social media network server.

The list of anonymous social media identifications as shown in FIG. 2 are used to generate a report that quantifies their relative affinity or propensity to engage with various television programs. As such, FIG. 3 illustrates a matrix of television program engagement indices for four brand segments created using behavioural engagement patterns of users on social media networks. Here, it is shown that brand #3 has a strong relationship with television program #2, and a somewhat medium relationship with television programs #1 and #5, and no, or a minor, relationship with the television programs #3, #4, #6, #7 and #8.

This data could already be used for selecting advertising messages. That is, television programs #2 could be selected for brand #3. So, each time a commercial break is shown on television during television program #2, brand #3 could be used as an advertising message. The inventors, however, go one step further. They noted that it is not a television program that should be coupled to a particular brand, but a user should be coupled to the brand. In order to accomplish that, data from the recipient database is used which is then matched to the matrix of FIG. 3.

First, the television program names from social media networks aligned to a user/respondent level television viewing dataset such as cable set top box data, Smart TV data, or TV audience measurement panel data to form a common set of variables, i.e. behavioural variables, that will inform the translation of the segment.

At the most granular user record level such and household or person supported by the TV viewing dataset metrics that express a user's rate of viewing, share of user's total viewing, loyalty, and other viewing metrics across time for each program that will be used in the translation process. The user level viewing metrics are then used to compute a user level index for each program. When a very large number of behavioural attributes will be used to inform the linkage, factor analysis can be used to compute factors that explain the variance of the full set of behavioural attributes, but reduce the size of the matrices to help optimize the speed of computational execution and help simplify interpretation of the output.

FIG. 4 shows data retrieved from the recipient database which shows strengths of relationships between the plurality of recipient users, i.e. television panel respondents, and the behavioural variables, i.e. programs #1-#8.

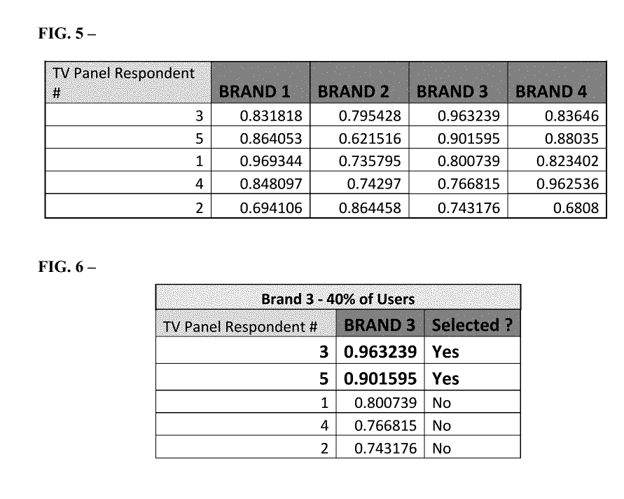

For each of the users, an aggregate similarity score is calculated ranging from a value of 0 representing totally dissimilarity to a value of 1 representing a perfect match that compares the distribution of indices between the user and the aggregate profile report derived from the behaviour of social media users as illustrated in FIG. 5. FIG. 5 thus illustrates a matrix in which the data from FIG. 3 and the data from FIG. 4 are combined.

For applications that require the selection of unique users, an estimate of the size of the target expressed as a percentage of active users can be sourced from social media data to inform the selection of users. The users are sorted by descending order by similarity score and the corresponding top X % users are selected as being in the discrete audience segment as illustrated in FIG. 6. Other similarity score cut-offs such as the top quartile can be used when applicable. So, for example, it is shown that television panel respondent #3 has the best score to brand #3, and panel respondent #5 has the best score to brand #3, and that both of these are selected.

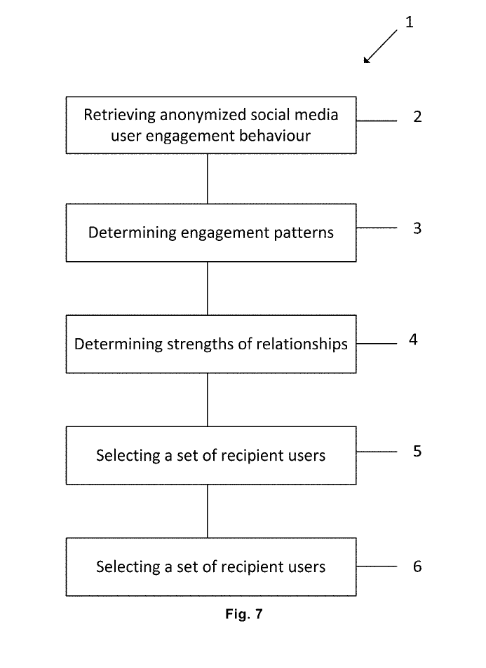

FIG. 7 illustrates a flow chart illustrating an embodiment of a method 1 according to the present invention.

The method comprising the steps of:

a) retrieving 2, by said computing server, anonymized social media user engagement behaviour at a first social media platform to define an audience segment desired to inform the targeting of advertising on said second platform, said audience segment comprising a plurality of anonymous user identifications, and wherein said engagement behaviour is defined as an affinity of each of said plurality of anonymous user identifications with one or more brands;
b) determining 3, by said computing server, using said retrieved anonymized social media user engagement behaviour, engagement patterns of the plurality of anonymous user identifications across a matrix, said matrix having a first dimension related to said one or more brands and a second dimension related to said one or more particular behavioural variables, thereby obtaining relationships of said one or more brands with said one or more particular behavioural variables;
c) determining 4, by said computing server, by accessing said recipient database, strengths of relationships between said plurality of recipient users and said one or more particular behavioural variables, thereby obtaining relationships of said plurality of recipient users with said one or more particular behavioural variables;
d) selecting 5, by said computing server, a set of recipient users being a subset of said plurality of recipient users at said second platform to which said advertising is to be delivered, said selecting based on said obtained relationships of:
said one or more brands with said one or more particular behavioural variables, and
said plurality of recipient users with said one or more particular behavioural variables;
   e) delivering 6, by said computing server, at said second platform, said advertising to said selected set of recipient users

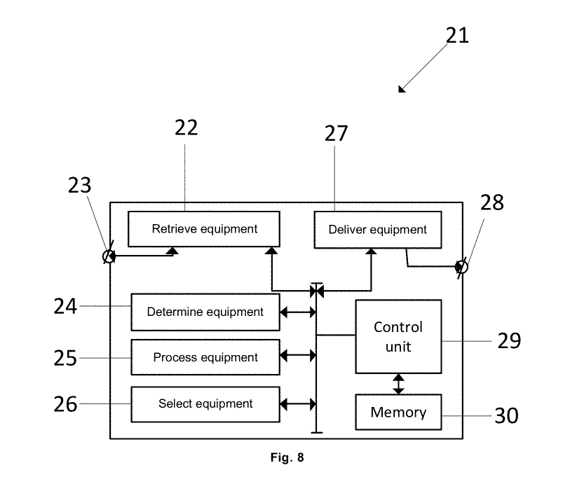

FIG. 8 illustrates a computing server in according with the present invention.

The computing server 21 is arranged for delivering a targeted advertising to a selected set of recipient users, said computing server in connection with a recipient database comprising a plurality of recipient users at a second platform as well as one or more behavioural variables, said computing server comprising:

retrieve equipment 22, via terminal 23, arranged for retrieving anonymized social media user engagement behaviour at a first social media platform to define an audience segment desired to inform the targeting of advertising on said second platform, said audience segment comprising a plurality of anonymous user identifications, and wherein said engagement behaviour is defined as an affinity of each of said plurality of anonymous user identifications with one or more brands;

determine equipment 24 arranged for determining using said retrieved anonymized social media user engagement behaviour, engagement patterns of the plurality of anonymous user identifications across a matrix, said matrix having a first dimension related to said one or more brands and a second dimension related to said one or more particular behavioural variables, thereby obtaining relationships of said one or more brands with said one or more particular behavioural variables;

process equipment 25 arranged for determining, by accessing said recipient database, strengths of relationships between said plurality of recipient users and said one or more particular behavioural variables, thereby obtaining relationships of said plurality of recipient users with said one or more particular behavioural variables;

select equipment 26 arranged for selecting a set of recipient users being a subset of said plurality of recipient users at said second platform to which said advertising is to be delivered, said selecting based on said obtained relationships of:
said one or more brands with said one or more particular behavioural variables, and
said plurality of recipient users with said one or more particular behavioural variables;

deliver equipment 27, via output terminal 28, arranged for delivering at said second platform, said advertising to said selected set of recipient users.

The com[putting server 21 further comprising a control unit 29 in connection with a memory 30, wherein said control unit is arranged to control the retrieve equipment 22, the determine equipment 24, the process equipment 25, the select equipment 26 and the deliver equipment 27.

The present disclosure is not limited to the embodiments as disclosed above, and can be modified and enhanced by those skilled in the art beyond the scope of the present disclosure as disclosed in the appended claims without having to apply inventive skills.

1. A method for delivering a targeted advertising to a selected set of recipient users, said method being performed by a computing server in connection with a recipient database comprising a plurality of recipient users at a second platform as well as one or more behavioural variables, said method comprising the steps of:
a) retrieving, by said computing server, anonymized social media user engagement behaviour at a first social media platform to define an audience segment desired to inform the targeting of advertising on said second platform, said audience segment comprising a plurality of anonymous user identifications, and wherein said engagement behaviour is defined as an affinity of each of said plurality of anonymous user identifications with one or more brands;
b) determining, by said computing server, using said retrieved anonymized social media user engagement behaviour, engagement patterns of the plurality of anonymous user identifications across a matrix, said matrix having a first dimension related to said one or more brands and a second dimension related to said one or more particular behavioural variables, thereby obtaining relationships of said one or more brands with said one or more particular behavioural variables;
c) determining, by said computing server, by accessing said recipient database, strengths of relationships between said plurality of recipient users and said one or more particular behavioural variables, thereby obtaining relationships of said plurality of recipient users with said one or more particular behavioural variables;
d) selecting, by said computing server, a set of recipient users being a subset of said plurality of recipient users at said second platform to which said advertising is to be delivered, said selecting based on said obtained relationships of:
said one or more brands with said one or more particular behavioural variables, and
said plurality of recipient users with said one or more particular behavioural variables;
e) delivering, by said computing server, at said second platform, said advertising to said selected set of recipient users.

2. The method according to claim 1, wherein said step b) further comprises the step of:
calculating, by said computing server, indices that quantify strengths of said relationships of said one or more brands with said one or more particular behavioural variables.

3. The method according to claim 1, wherein said step c) further comprises the step of:
calculating, by said computing server, indices that quantify strengths of said relationships of said plurality of recipient users with said one or more particular behavioural variables.

4. The method according to claim 2, wherein said step d) further comprises:
selecting a set of recipient users based on a calculated degree of similarity of indices related to said strengths of said relationships of said one or more brands with said one or more particular behavioural variables and said indices related to said strengths of said relationships of said plurality of recipient users with said one or more particular behavioural variables.

5. The method according to claim 1, wherein said one or more behavioural variables comprise television programs.

6. The method according to claim 1, wherein said step c) comprises determining, by said computing server, by accessing said recipient database, strengths of relationships between said plurality of recipient users and said one or more particular behavioural variables by analysing historic user patterns of said plurality of recipient users with respect to said one or more particular behavioural variables.

7. A computing server for delivering a targeted advertising to a selected set of recipient users, said computing server in connection with a recipient database comprising a plurality of recipient users at a second platform as well as one or more behavioural variables, said computing server comprising:
retrieve equipment arranged for retrieving anonymized social media user engagement behaviour at a first social media platform to define an audience segment desired to inform the targeting of advertising on said second platform, said audience segment comprising a plurality of anonymous user identifications, and wherein said engagement behaviour is defined as an affinity of each of said plurality of anonymous user identifications with one or more brands;
determine equipment arranged for determining using said retrieved anonymized social media user engagement behaviour, engagement patterns of the plurality of anonymous user identifications across a matrix, said matrix having a first dimension related to said one or more brands and a second dimension related to said one or more particular behavioural variables, thereby obtaining relationships of said one or more brands with said one or more particular behavioural variables;
process equipment arranged for determining, by accessing said recipient database, strengths of relationships between said plurality of recipient users and said one or more particular behavioural variables, thereby obtaining relationships of said plurality of recipient users with said one or more particular behavioural variables;
select equipment arranged for selecting a set of recipient users being a subset of said plurality of recipient users at said second platform to which said advertising is to be delivered, said selecting based on said obtained relationships of:
said one or more brands with said one or more particular behavioural variables, and
said plurality of recipient users with said one or more particular behavioural variables;
deliver equipment arranged for delivering at said second platform, said advertising to said selected set of recipient users.

8. The computing server according to claim 7, wherein said determine equipment is further arranged for:
calculating, by said computing server, indices that quantify strengths of said relationships of said one or more brands with said one or more particular behavioural variables.

9. The computing server according to claim 7, wherein said process equipment is further arranged for:
calculating, by said computing server, indices that quantify strengths of said relationships of said plurality of recipient users with said one or more particular behavioural variables.

10. The computing server according to claim 8, wherein said select equipment is further arranged for:
selecting a set of recipient users based on a calculated degree of similarity of indices related to said strengths of said relationships of said one or more brands with said one or more particular behavioural variables and said indices related to said strengths of said relationships of said plurality of recipient users with said one or more particular behavioural variables.

11. The computing server according to claim 7, wherein said one or more behavioural variables comprise television programs.

12. The computing server according to claim 7, wherein said process equipment is further arranged for determining, by said computing server, by accessing said recipient database, strengths of relationships between said plurality of recipient users and said one or more particular behavioural variables by analysing historic user patterns of said plurality of recipient users with respect to said one or more particular behavioural variables.
